(19) United States
(12) Patent Application Publication
(10) Pub. No.: US 2012/0301640 A1
(43) Pub. Date: Nov. 29, 2012

(54) TRANSPARENT INK-JET RECORDING FILMS, COMPOSITIONS, AND METHODS

(76) Inventors: Sharon M. Simpson, Lake Elmo, MN (US); Daniel P. Leach, Rochester, NY (US); William J. Ruzinsky, Loveland, CO (US); William D. Devine, Fort Collins, CO (US)

(21) Appl. No.: 13/474,747

(22) Filed: May 18, 2012

Related U.S. Application Data
(60) Provisional application No. 61/490,615, filed on May 27, 2011.

(51) Int. Cl. B41M 5/50; B05D 5/04

(52) U.S. Cl. 428/32.13; 427/407.1

(57) ABSTRACT

The compositions and methods of the present application can provide transparent ink-jet recording films with increased image-receiving layer thicknesses. Such films can exhibit high maximum optical densities and rapid ink drying.

### CROSS REFERENCE TO RELATED APPLICATIONS

This application claims the benefit of U.S. provisional application No. 61/490,615, filed May 27, 2011, entitled TRANSPARENT INK-JET RECORDING FILMS, COMPOSITIONS, AND METHODS, which is hereby incorporated by reference in its entirety.

### SUMMARY

Transparent ink-jet recording films often employ one or more image-receiving layers on one or both sides of a transparent support. In order to obtain high image densities when printing on transparent films, more ink is often applied than is required for opaque films. To be able to accommodate more printing ink, image-receiving layer thicknesses can be increased relative to those in opaque films. The compositions and methods of the present application can provide transparent ink-jet recording films with increased image-receiving layer thicknesses. Such films can exhibit high maximum optical densities and rapid ink drying.

At least a first embodiment provides methods comprising forming a first composition comprising gelatin; forming a second composition by a first method comprising adding at least one borate or borate derivative to the first composition, the second composition comprising at least one anionic polymer; and forming a transparent ink-jet recording film by a second method comprising forming at least one under-layer from the second composition.

In some embodiments, the second method further comprises forming a third composition comprising at least one inorganic particle and at least one water soluble or water dispersible polymer comprising at least one hydroxyl group; and forming at least one image-receiving layer from the third composition, the at least one image-receiving layer being disposed on the at least one under-layer. In such methods, the at least one inorganic particle may, for example, comprise boehmite alumina and the at least one water soluble or water dispersible polymer may, for example, comprise polyvinyl alcohol.

In any of these methods, the at least one borate or borate derivative may, for example, comprises at least one hydrate of sodium tetraborate, such as, for example, sodium tetraborate decahydrate.

Polystyrene sulfonate is an exemplary anionic polymer.

In some embodiments, the first method comprises adding the at least one borate or borate derivative to the first composition to form a fourth composition; and combining the at least one anionic polymer and the fourth composition to form the second composition.

Other embodiments provide the transparent ink-jet recording films prepared by any of these methods.

At least a second embodiment provides transparent ink-jet recording films exhibiting superior ink-drying performance prepared by a method comprising forming a first composition comprising gelatin; forming a second composition by a first method comprising adding at least one borate or borate derivative to the first composition, the second composition comprising at least one anionic polymer; and forming the transparent ink-jet recording film by a second method comprising forming at least one under-layer from the second composition.

At least a third embodiment provide methods comprising forming a first composition comprising gelatin; forming a second composition comprising at least one borate or borate derivative; and forming a transparent ink-jet film by a method comprising forming an under-layer coating from the second composition.

In at least some embodiments, the at least one borate or borate derivative may comprise at least one hydrate of sodium tetraborate, such as, for example, sodium tetraborate decahydrate.

In at least some embodiments, the second composition may further comprise at least one anionic polymer, such as, for example, polystyrene sulfonate.

In at least some embodiments, such methods further comprise forming an image-receiving layer coating mix comprising at least one inorganic particle and at least one water soluble or water dispersible polymer comprising at least one hydroxyl group; and forming an image receiving layer form the image-receiving layer coating mix.

Other embodiments provide transparent ink-jet films produced according to such methods.

At least a fourth embodiment provides methods comprising forming a first composition comprising gelatin; forming a second composition comprising at least one borate or borate derivative and the first composition; forming a third composition comprising at least one anionic polymer and the second composition; and forming a transparent ink-jet film by a method comprising forming an under-layer from the third composition.

In at least some embodiments, the at least one borate or borate derivative may comprise at least one hydrate of sodium tetraborate, such as, for example, sodium tetraborate decahydrate.

In at least some embodiments, at least one anionic polymer may comprise polystyrene sulfonate.

In at least some embodiments, such methods further comprise forming an image-receiving layer coating mix comprising at least one inorganic particle and at least one water soluble or water dispersible polymer comprising at least one hydroxyl group; and forming an image receiving layer form the image-receiving layer coating mix.

Other embodiments provide transparent ink-jet films produced according to such methods.

These embodiments and other variations and modifications may be better understood from the description, exemplary embodiments, examples, and claims that follow. Any embodiments provided are given only by way of illustrative example. Other desirable objectives and advantages inherently achieved may occur or become apparent to those skilled in the art.

### DESCRIPTION

All publications, patents, and patent documents referred to in this document are incorporated by reference herein in their entirety, as though individually incorporated by reference.

U.S. provisional application No. 61/490,615, filed May 27, 2011, entitled TRANSPARENT INK-JET RECORDING FILMS, COMPOSITIONS, AND METHODS, is hereby incorporated by reference in its entirety.

### Introduction

An ink-jet recording film may comprise at least one image-receiving layer, which receives ink from an ink-jet printer during printing, and a substrate or support, which may be opaque or transparent. An opaque support may be used in films that may be viewed using light reflected by a reflective backing, while a transparent support may be used in films that may be viewed using light transmitted through the film.

Some medical imaging applications require high image densities. For a reflective film, high image densities may be achieved by virtue of the light being absorbed on both its path into the imaged film and again on the light's path back out of the imaged film from the reflective backing. On the other hand, for a transparent film, because of the lack of a reflective backing, achievement of high image densities may require application of larger quantities of ink than are common for opaque films.

Application of such quantities of ink during printing increases the amount of carrier fluids that must be removed after printing. Because of the high throughput of many ink-jet printers, the removal of such carrier fluids may be incomplete.

Transparent ink-jet films, compositions, and methods are presented that provide superior ink drying performance when printed to optical densities of, for example, at least about 2.8.

### Transparent Ink-Jet Films

Transparent ink-jet recording films are known in the art. See, for example, U.S. provisional patent application 61/393,359, “TRANSPARENT INK-JET RECORDING FILM,” by Simpson et al., filed Jul. 12, 2010, and U.S. provisional patent application 61/375,325, “SMUDGE-RESISTANCE OF MATTE BLACK INKS AND DRYING OF INKS USING A 2-LAYER INKJET RECEPTOR CONTAINING A MONOSACCHARIDE OR DISACCHARIDE ON A TRANSPARENT SUPPORT,” by Simpson et al., filed Aug. 20, 2010, both of which are herein incorporated by reference in their entirety.

Transparent ink-jet recording films may comprise one or more transparent substrates upon which at least one under-layer may be coated. Such an under-layer may optionally be dried before being further processed. The film may further comprise one or more image-receiving layers coated upon at least one under-layer. Such an image-receiving layer is generally dried after coating. In some embodiments, the film may further comprise additional layers, such as one or more back-coat layers or overcoat layers, as will be understood by those skilled in the art.

### Transparent Substrate

Transparent substrates may be flexible, transparent films made from polymeric materials, such as, for example, polyethylene terephthalate, polyethylene naphthalate, cellulose acetate, other cellulose esters, polyvinyl acetal, polyolefins, polycarbonates, polystyrenes, and the like. In some embodiments, polymeric materials exhibiting good dimensional stability may be used, such as, for example, polyethylene terephthalate, polyethylene naphthalate, other polyesters, or polycarbonates.

Other examples of transparent substrates are transparent, multilayer polymeric supports, such as those described in U.S. Pat. No. 6,630,283 to Simpson, et al., which is hereby incorporated by reference in its entirety. Still other examples of transparent supports are those comprising dichroic mirror layers, such as those described in U.S. Pat. No. 5,795,708 to Boutet, which is hereby incorporated by reference in its entirety.

Transparent substrates may optionally contain colorants, pigments, dyes, and the like, to provide various background colors and tones for the image. For example, a blue tinting dye is commonly used in some medical imaging applications. These and other components may optionally be included in the transparent substrate, as will be understood by those skilled in the art.

In some embodiments, the transparent substrate may be provided as a continuous or semi-continuous web, which travels past the various coating, drying, and cutting stations in a continuous or semi-continuous process.

### Under-Layer Coating Mix

Under-layers may be formed by applying at least one under-layer coating mix to one or more transparent substrates. The under-layer coating mix may comprise gelatin. In at least some embodiments, the gelatin may be a Regular Type IV bovine gelatin. The under-layer coating mix may further comprise at least one borate or borate derivative, such as, for example, sodium borate, sodium tetraborate, sodium tetraborate decahydrate, boric acid, phenyl boronic acid, butyl boronic acid, and the like. More than one type of borate or borate derivative may optionally be included in the under-layer coating mix. In some embodiments, the borate or borate derivative may be used in an amount of up to, for example, about 2 g/m². In at least some embodiments, the ratio of the at least one borate or borate derivative to the gelatin may be between about 20:80 and about 1:1 by weight, or the ratio may be about 0.45:1 by weight. In some embodiments, the under-layer coating mix may comprise, for example, at least about 4 wt % solids, or at least about 9.2 wt % solids. The under-layer coating mix may comprise, for example, about 15 wt % solids.

The under-layer coating mix may also comprise a thickener. Examples of suitable thickeners include, for example, anionic polymers, such as sodium polystyrene sulfonate, other salts of polystyrene sulfonate, salts of copolymers comprising styrene sulfonate repeat units, anionically modified polyvinyl alcohols, and the like.

When preparing mixes comprising gelatin and at least one anionic polymer thickener, such mixes may become too viscous to be suitable for coating. However, mix viscosities may be controlled by first mixing the gelatin with the at least one borate or borate derivative, before adding the at least one anionic polymer thickener to the mix.

In at least some embodiments, the anionic polymer thickener may have a weight average molecular weight greater than about 100,000 g/mol, or greater than about 500,000 g/mol, or greater than about 900,000 g/mol. In some embodiments, the at least one anionic polymer may have a weight average molecular weight of about 1,000,000 g/mol.

In some embodiments, the under-layer coating mix may optionally further comprise other components, such as surfactants, such as, for example, nonyl phenol, glycidyl polyether. In some embodiments, such a surfactant may be used in amount from about 0.001 to about 0.20 g/m², as measured in the under-layer. These and other optional mix components will be understood by those skilled in the art.

### Image-Receiving Layer Coating Mix

Image-receiving layers may be formed by applying at least one image-receiving layer coating mix to one or more under-layer coatings. The image-receiving coating mix may comprise at least one water soluble or dispersible cross-linkable polymer comprising at least one hydroxyl group, such as, for example, poly(vinyl alcohol), partially hydrolyzed poly(vinyl acetate/vinyl alcohol), copolymers containing hydroxyethylmethacrylate, copolymers containing hydroxyethylacrylate, copolymers containing hydroxypropylmethacrylate, hydroxy cellulose ethers, such as, for example, hydroxyethylcellulose, and the like. More than one type of water soluble or water dispersible cross-linkable polymer may optionally be included in the under-layer coating mix. In some embodiments, the at least one water soluble or water dispersible polymer may be used in an amount of up to about 1.0 to about 4.5 g/m², as measured in the image-receiving layer.

The image-receiving layer coating mix may also comprise at least one inorganic particle, such as, for example, metal oxides, hydrated metal oxides, boehmite alumina, clay, calcined clay, calcium carbonate, aluminosilicates, zeolites, barium sulfate, and the like. Non-limiting examples of inorganic particles include silica, alumina, zirconia, and titania. Other non-limiting examples of inorganic particles include fumed silica, fumed alumina, and colloidal silica. In some embodiments, fumed silica or fumed alumina have primary particle sizes up to about 50 nm in diameter, with aggregates being less than about 300 nm in diameter, for example, aggregates of about 160 nm in diameter. In some embodiments, colloidal silica or boehmite alumina have particle size less than about 15 nm in diameter, such as, for example, 14 nm in diameter. More than one type of inorganic particle may optionally be included in the image-receiving coating mix.

In at least some embodiments, the ratio of inorganic particles to polymer in the at least one image-receiving layer coating mix may be, for example, between about 88:12 and about 95:5 by weight, or the ratio may be about 92:8 by weight.

Image-receiving layer coating layer mixes prepared from alumina mixes with higher solids fractions can perform well in this application. However, high solids alumina mixes can, in general, become too viscous to be processed. It has been discovered that suitable alumina mixes can be prepared at, for example, 25 wt % or 30 wt % solids, where such mixes comprise alumina, nitric acid, and water, and where such mixes comprise a pH below about 3.09, or below about 2.73, or between about 2.17 and about 2.73. During preparation, such alumina mixes may optionally be heated, for example, to 80° C.

The image-receiving coating layer mix may also comprise one or more surfactants such as, for example, nonyl phenol, glycidyl polyether. In some embodiments, such a surfactant may be used in amount of, for example, about 1.5 g/m², as measured in the image-receiving layer. In some embodiments, the image-receiving coating layer may also optionally comprise one or more acids, such as, for example, nitric acid.

These and components may optionally be included in the image-receiving coating layer mix, as will be understood by those skilled in the art.

### Back-coat Layer Coating Mix

Back-coat layers may be formed by applying at least one back-coat coating mix to one or more transparent substrates. In some embodiments, the at least one back-coat layer coating mix may be applied on the side of the one or more transparent substrates opposite to that which the under-layer coating mix or image receiving layer coating mix is applied.

The at least one back-coat layer coating mix may comprise gelatin. In at least some embodiments, the gelatin may be a Regular Type IV bovine gelatin.

The at least one back-coat layer coating mix may further comprise other hydrophilic colloids, such as, for example, dextran, gum arabic, zein, casein, pectin, collagen derivatives, collodion, agar-agar, arrowroot, albumin, and the like. Other examples of hydrophilic colloids are water-soluble polyvinyl compounds such as polyvinyl alcohol, polyacrylamides, polymethacrylamide, poly(N,N-dimethacrylamide), poly(N-isopropylacrylamide), poly(vinylpyrrolidone), poly(vinyl acetate), polyalkylene oxides such as polyethylene oxide, poly(6,2-ethyloxazolines), polystyrene sulfonate, polysaccharides, or cellulose derivatives such as carboxymethyl cellulose, hydroxyethyl cellulose, their sodium salts, and the like.

In at least some embodiments, the at least one back-coat layer may further comprise at least one other hydrophilic colloid comprising at least one of sodium carboxymethylate casein or a polyacrylamide. In some case, the at least some cases, the at least one back-coat layer may comprise both sodium carboxymethylate casein and a polyacrylamide.

In some cases, the at least one back-coat layer may further comprise at least one polysiloxane. Such compounds are sometimes referred to as silicones, because of the presence of silicon-oxygen bonds in their backbone chain.

The at least one back-coat layer coating mix may further comprise at least one core-shell particle comprising at least one thermoplastic polymer and at least one colloidal inorganic particle, where at least a portion of the at least one thermoplastic is coated with the at least one colloidal inorganic particle. The at least one thermoplastic polymer may be referred to as the core material and the at least one colloidal inorganic particle may be referred to as the shell material. Such core-shell particles may be, for example, from about 0.5 μm to about 10 μm in diameter. The ratio of thermoplastic polymers to the colloidal inorganic particles may be from about 5:1 to about 99:1, or from about 15:1 to about 50:1. Examples of suitable thermoplastic polymers include, for example, polyesters, acrylic polymers, styrenic polymers, and the like. Such thermoplastic polymers may have softening points, as measured by ASTM E28 ring and ball method, of at least about 50° C., or from about 50° C. to about 120° C. In some embodiments, the at least one thermoplastic polymer comprises a styrene allyl alcohol copolymer. Examples of suitable colloidal inorganic particles include, for example, colloidal silicas, modified colloidal silicas, colloidal aluminas, and the like. Such colloidal inorganic particles may be, for example, from about 5 nm to about 100 nm in diameter. Further examples of suitable core-shell particles are described in U.S. Pat. No. 6,457,824 to Wexler, which is hereby incorporated by reference in its entirety.

In some cases, the at least one core-shell polymer may comprise a dry coverage of at least about 120 mg/m², such as, for example, a dry coverage of at least about 120 mg/m² and less than about 200 mg/m². Or the at least one core-shell polymer may, for example, comprise a dry coverage of at least about 100 mg/m² and less than about 500 mg/m², or a dry coverage of at least about 100 mg/m² and less than about 1000 mg/m².

The at least one back-coat layer coating mix may optionally further comprise colloidal inorganic particles in addition to any that may be supplied as a coating of a thermoplastic polymer.

The at least one back-coat layer coating mix may further comprise at least one hardening agent. In some embodiments, the at least one hardening agent may be added to the coating mix as the coating mix is being applied to the substrate, for example, by adding the at least one hardening agent up-stream of an in-line mixer located in a line downstream of the back-coat coating mix tank. In some embodiments, such hardeners may include, for example, 1,2-bis(vinylsulfonylacetamido)ethane, bis(vinylsulfonyl)methane, bis(vinylsulfonylmethyl)ether, bis(vinylsulfonylethyl)ether, 1,3-bis(vinylsulfonyl)propane, 1,3-bis(vinylsulfonyl)-2-hydroxypropane, 1,1-bis(vinylsulfonyl)ethylbenzenesulfonate sodium salt, 1,1,1-tris(vinylsulfonyl)ethane, tetrakis(vinylsulfonyl)methane, tris(acrylamido)hexahydro-s-triazine, copoly(acrolein-methacrylic acid), glycidyl ethers, acrylamides, dialdehydes, blocked dialdehydes, alpha-diketones, active esters, sulfonate esters, active halogen compounds, s-triazines, diazines, epoxides, formaldehydes, formaldehyde condensation products anhydrides, aziridines, active olefins, blocked active olefins, mixed function hardeners such as halogen-substituted aldehyde acids, vinyl sulfones containing other hardening functional groups, 2,3-dihydroxy-1,4-dioxane, potassium chrome alum, polymeric hardeners such as polymeric aldehydes, polymeric vinylsulfones, polymeric blocked vinyl sulfones and polymeric active halogens. In some embodiments, the at least one hardening agent may comprise a vinylsulfonyl compound, such as, for example bis(vinylsulfonyl)methane, 1,2-bis(vinylsulfonyl)ethane, 1,1-bis(vinylsulfonyl)ethane, 2,2-bis(vinylsulfonyl)propane, 1,1-bis(vinylsulfonyl)propane, 1,3-bis(vinylsulfonyl)propane, 1,4-bis(vinylsulfonyl)butane, 1,5-bis(vinylsulfonyl)pentane, 1,6-bis(vinylsulfonyl)hexane, and the like.

In at least some embodiments, the at least one back-coat layer may comprise at least one first layer and at least one second layer, where the at least one first layer is disposed between the at least one second layer and the second surface of the substrate. The at least one first layer may, for example, comprise gelatin and at least one hardener. The at least one second layer may, for example, comprise gelatin and the at least one core-shell particle. In some cases, the at least one second layer further comprises at least one other hydrophilic colloid comprising at least one of sodium carboyxmethylate casein or a polyacrylamide, or, for example, the at least one second layer may comprise both sodium carboxymethylate casein and a polyacrylamide. In at least some cases, the at least one second layer further comprises at least one polysiloxane.

In some embodiments, the at least one back-coat layer coating mix may optionally further comprise at least one surfactant, such as, for example, one or more anionic surfactants, one or more cationic surfactants, one or more fluorosurfactants, one or more nonionic surfactants, and the like. These and other optional mix components will be understood by those skilled in the art.

### Coating

The at least one under-layer and at least one image-receiving layer may be coated from mixes onto the transparent substrate. The various mixes may use the same or different solvents, such as, for example, water or organic solvents. Layers may be coated one at a time, or two or more layers may be coated simultaneously. For example, simultaneously with application of an under-layer coating mix to the support, an image-receiving layer may be applied to the wet under-layer using such methods as, for example, slide coating.

The at least one back-coat layer may be coated from at least one mix onto the opposite side of the transparent substrate from the side on which the at least one under-layer coating mix and the at least one image-receiving layer coating mix are coated. In at least some embodiments, two or more mixes may be combined and mixed using an in-line mixer to form the coating that is applied to the substrate. The at least one back-coat layer may be applied simultaneously with the application of either of the at least one under-layer or at least one image receiving layer, or may be coated independently of the application of the other layers.

Layers may be coated using any suitable methods, including, for example, dip-coating, wound-wire rod coating, doctor blade coating, air knife coating, gravure roll coating, reverse-roll coating, slide coating, bead coating, extrusion coating, curtain coating, and the like. Examples of some coating methods are described in, for example, Research Disclosure, No. 308119, December 1989, pp. 1007-08, (available from Research Disclosure, 145 Main St., Ossining, N.Y., 10562, http://www.researchdisclosure.com).

### Drying

Coated layers, such as, for example under-layers or image-receiving layers, may be dried using a variety of known methods. Examples of some drying methods are described in, for example, Research Disclosure, No. 308119, December 1989, pp. 1007-08, (available from Research Disclosure, 145 Main St., Ossining, N.Y., 10562, http://www.researchdisclosure.com). In some embodiments, coating layers may be dried as they travel past one or more perforated plates through which a gas, such as, for example, air or nitrogen, passes. Such an impingement air dryer is described in U.S. Pat. No. 4,365,423 to After et al., which is incorporated by reference in its entirety. The perforated plates in such a dryer may comprise perforations, such as, for example, holes, slots, nozzles, and the like. The flow rate of gas through the perforated plates may be indicated by the differential gas pressure across the plates. The ability of the gas to remove water may be limited by its dew point, while its ability to remove organic solvents may be limited by the amount of such solvents in the gas, as will be understood by those skilled in the art.

### Other Layers

In some embodiments, the transparent ink-jet recording film may comprise other layers, such as, for example, primer layers or subbing layers disposed between the at least one under-layer and the transparent substrate, or disposed between the at least one back-coat layer and the transparent substrate, or both. In at least some embodiments, at least one subbing layer may be disposed on at least one primer layer. Such layers may, for example, be coated and dried using processes similar to those described for applying under-layers and image-receiving layers.

In embodiments comprising at least one primer layer, such primer layers may, for example, be adjacent to one or more of the substrate surfaces, with the other layers disposed on the primer layers. Primer layers may be used in combination with or in lieu of treatment of the substrate surface. In some embodiments, a primer layer may comprise a coating thickness of about 0.112 g/m² on a dry basis.

Such primer layers may comprise adhesion promoters, such as phenolic or naphtholic compounds substituted with one or more hydroxyl groups, including but not limited to, for example, phenol, resorcinol, orcinol, catechol, pyrogallol, 2,4-dinitrophenol, 2,4,6-trinitrophenol, 4-chlororesorcinol, 2,4-dihydroxy toluene, 1,3-naphthalenediol, the sodium salt of 1-naphthol-4-sulfonic acid, o-fluorophenol, m-fluorophenol, p-fluorophenol, o-cresol, p-hydroxybenzotrifluoride, gallic acid, 1-naphthol, chlorophenol, hexyl resorcinol, chloromethylphenol, o-hydroxybenzotrifluoride, m-hydroxybenzotrifluoride, p-chloro-m-xylenol, and the like. Other examples of adhesion promoters include acrylic acid, benzyl alcohol, trichloroacetic acid, dichloroacetic acid, chloral hydrate, ethylene carbonate, and the like. These or other adhesion promoters may be used as a single adhesion promoter or as mixtures of two or more adhesion promoters.

Such primer layers may comprise one or more polymers. Often these include polymers of monomers having polar groups in the molecule such as carboxyl, carbonyl, hydroxy, sulfo, amino, amido, epoxy or acid anhydride groups, for example, acrylic acid, sodium acrylate, methacrylic acid, itaconic acid, crotonic acid, sorbic acid, itaconic anhydride, maleic anhydride, cinnamic acid, methyl vinyl ketone, hydroxyethyl acrylate, hydroxyethyl methacrylate, hydroxychloropropyl methacrylate, hydroxybutyl acrylate, vinylsulfonic acid, potassium vinylbenezensulfonate, acrylamide, N-methylamide, N-methylacrylamide, acryloylmorpholine, dimethylmethacrylamide, N-t-butylacrylamide, diacetonacrylamide, vinylpyrrolidone, glycidyl acrylate, or glycidyl methacrylate, or copolymers of the above monomers with other copolymerizable monomers. Additional examples are polymers of, for example, acrylic acid esters such as ethyl acrylate or butyl acrylate, methacrylic acid esters such as methyl methacrylate or ethyl methacrylate or copolymers of these monomers with other vinylic monomers; or copolymers of polycarboxylic acids such as itaconic acid, itaconic anhydride, maleic acid or maleic anhydride with vinylic monomers such as styrene, vinyl chloride, vinylidene chloride or butadiene, or trimers of these monomers with other ethylenically unsaturated monomers. Materials used in primer layers often comprise a copolymer containing a chloride group such as vinylidene chloride. In some embodiments, a terpolymer of monomers comprising about 83 wt % vinylidene chloride, about 15 wt % methyl acrylate, and about 2 wt % itaconic acid may be used, as described in U.S. Pat. No. 3,143,421 to Nadeau et al., which is hereby incorporated by reference in its entirety.

In some embodiments, the one or more polymers may be provided as a latex dispersion. Such a latex dispersion may be prepared by, for example, emulsion polymerization. In other embodiments, the one or polymers may be prepared by solution polymerization, followed by dispersion of the polymers in water to form a latex dispersion. Such polymers, when provided as a latex dispersion, may be referred to as latex polymers.

The one or more primer layer may optionally also comprise one or more surfactants, such as, for example, saponin. Such surfactants may be provided as part of one or more latex dispersions or may be provided in addition to any surfactants may be in such dispersions.

In some embodiments, the one or more primer layers may be applied to the transparent substrate prior to orientation of the substrate. Such orientation may comprise, for example, uniaxial or biaxial orientation at one or more temperatures above the glass transition temperature and below the melting temperature of the transparent substrate.

In embodiments comprising at least one subbing layer, such subbing layers may, for example, be applied to one or more surfaces of a transparent substrate or to one or more primer layers disposed on such surfaces. Generally, such subbing layers, when present, are adjacent to the one or more primer layers, when present, or are adjacent to one or more of the substrate surfaces, when the one or more primer layers are absent. In some embodiments, for example, where the one or more primer layers do not completely cover a substrate surface, the one or more subbing layer may be adjacent to both that substrate surface and to the one or more primer layers. In some embodiments, a subbing layer may comprise a coating thickness of about 0.143 g/m² on a dry basis.

In some embodiments, the one or more subbing layers may comprise gelatin, such as, for example, Regular Type IV bovine gelatin, alkali-treated gelatin, acid-treated gelatin, phthalate-modified gelatin, vinyl polymer-modified gelatin, acetylated gelatin, deionized gelatin, and the like.

Such subbing layers may comprise one or more polymers. In some embodiments, such polymers may comprise polymers of monomers comprising polar groups in the molecule such as carboxyl, carbonyl, hydroxy, sulfo, amino, amido, epoxy or acid anhydride groups, for example, acrylic acid, sodium acrylate, methacrylic acid, itaconic acid, crotonic acid, sorbic acid, itaconic anhydride, maleic anhydride, cinnamic acid, methyl vinyl ketone, hydroxyethyl acrylate, hydroxyethyl methacrylate, hydroxychloropropyl methacrylate, hydroxybutyl acrylate, vinylsulfonic acid, potassium vinylbenezensulfonate, acrylamide, N-methylamide, N-methylacrylamide, acryloylmorpholine, dimethylmethacrylamide, N-t-butylacrylamide, diacetonacrylamide, vinylpyrrolidone, glycidyl acrylate, or glycidyl methacrylate, or copolymers of the above monomers with other copolymerizable monomers. Additional examples are polymers of, for example, acrylic acid esters such as ethyl acrylate or butyl acrylate, methacrylic acid esters such as methyl methacrylate or ethyl methacrylate or copolymers of these monomers with other vinylic monomers; or copolymers of polycarboxylic acids such as itaconic acid, itaconic anhydride, maleic acid or maleic anhydride with vinylic monomers such as styrene, vinyl chloride, vinylidene chloride or butadiene, or trimers of these monomers with other ethylenically unsaturated monomers. In some embodiments, materials used in adhesion-promoting layers comprise polymers of one or more monomers containing a chloride group such as vinylidene chloride. In some embodiments, subbing layers may comprise one or more polymers comprising one or more polymeric matting agents. Such polymeric matting agents are described in U.S. Pat. No. 6,555,301 to Smith et al., which is hereby incorporated by reference in its entirety.

Such subbing layers may comprise one of more hardeners or crosslinking agents. In some embodiments, such hardeners may include, for example, 1,2-bis(vinylsulfonylacetamido)ethane, bis(vinylsulfonyl)methane, bis(vinylsulfonylmethyl)ether, bis(vinylsulfonylethyl)ether, 1,3-bis(vinylsulfonyl)propane, 1,3-bis(vinylsulfonyl)-2-hydroxypropane, 1,1-bis(vinylsulfonyl)ethylbenzenesulfonate sodium salt, 1,1,1-tris(vinylsulfonyl)ethane, tetrakis(vinylsulfonyl)methane, tris(acrylamido)hexahydro-s-triazine, copoly(acrolein-methacrylic acid), glycidyl ethers, acrylamides, dialdehydes, blocked dialdehydes, alpha-diketones, active esters, sulfonate esters, active halogen compounds, s-triazines, diazines, epoxides, formaldehydes, formaldehyde condensation products anhydrides, aziridines, active olefins, blocked active olefins, mixed function hardeners such as halogen-substituted aldehyde acids, vinyl sulfones containing other hardening functional groups, 2,3-dihydroxy-1,4-dioxane, potassium chrome alum, polymeric hardeners such as polymeric aldehydes, polymeric vinylsulfones, polymeric blocked vinyl sulfones and polymeric active halogens.

Such subbing layers may comprise one or more surfactants. In some embodiments, such surfactants may include, for example, anionic surface active agents such as alkali metal or ammonium salts of alcohol sulfuric acid of 8 to 18 carbon atoms; ethanolamine lauryl sulfate; ethylaminolauryl sulfate; alkali metal and ammonium salts of paraffin oil; alkali metal salts of aromatic sulfonic acid such as dodecane-1-sulfonic acid, octadiene-1-sulfonic acid or the like; alkali metal salts such as sodium isopropylbenzene-sulfate, sodium isobutylnaphthalenesulfate or the like; and alkali metal or ammonium salts of esters of sulfonated dicarboxylic acid such as sodium dioctylsulfosuccinate, disodium dioctadecylsulfosuccinate or the like; nonionic surface active agents such as saponin, sorbitan alkyl esters, polyethylene oxides, polyoxyethylene alkyl ethers or the like; cationic surface active agents such as octadecyl ammonium chloride, trimethyldosecyl ammonium chloride or the like; and high molecular surface active agents other than those above mentioned such as polyvinyl alcohol, partially saponified vinyl acetates, maleic acid containing copolymers, or the like.

Such subbing layers may be coated from, for example, aqueous mixes. In some embodiments, a portion of the water in such mixes may be replaced by one or more water miscible solvents. Such solvents may include, for example, ketones such as acetone or methyl ethyl ketone, alcohols such as ethanol, methanol, isopropanol, n-propanol, and butanol, and the like.

In some embodiments, one or more subbing layers may comprise one or more polymers comprising one or more polymeric matting agents. Such polymeric matting agents are described in U.S. Pat. No. 6,555,301 to Smith et al., which is hereby incorporated by reference in its entirety. Polymeric matting agents may have an average particle sizes from, for example, about 1.2 to about 3 micrometers and glass transition temperatures of, for example, at least about 135° C. or of at least about 150° C., as indicated by, for example, the onset in the change of heat capacity as measured by differential scanning calorimetry at a scan rate of 20° C./min. In some embodiments, polymeric matting agents may comprise copolymers of (A) recurring units derived from one or more polyfunctional ethylenically unsaturated polymerizable acrylates or methacrylates, and (B) recurring units derived from one or more monofunctional ethylenically unsaturated polymerizable acrylates or methacrylates having only one polymerizable site. Such copolymers may have compositions comprising, for example, from about 10 to about 30 wt % of (A) recurring units and from about 70 to about 90 wt % of (B) recurring units. Such copolymers may have compositions comprising at least about 5 wt % (A) recurring units, or at least about 10 wt % (A) recurring units, or up to about 30 wt % (A) recurring units, or up to about 50 wt % (A) recurring units. Such copolymers may have compositions comprising at least about 50 wt % (B) recurring units, or at least about 70 wt % (B) recurring units, or up to about 90 wt % (B) recurring units or up to about 95 wt % (B) recurring units.

Ethylenically unsaturated monomers represented by (A) include ethylenically unsaturated polymerizable compounds that have two or more functional groups that can be polymerized or reacted to form crosslinking sites within the polymer matrix. Thus, such monomers are considered “polyfunctional” with respect to the moieties used for polymerization and crosslinking. Representative monomers of this type include but are not limited to, aromatic divinyl compounds (such as divinylbenzene, divinylnaphthalene, and derivatives thereof), diethylene carboxylate esters (that is, acrylate and methacrylates) and amides (such as ethylene glycol dimethacrylate, diethylene glycol dimethacrylate, triethylene glycol dimethacrylate, ethylene glycol diacrylate, diethylene glycol diacrylate, 1,6-hexanediol dimethacrylate, 1,6-hexanediol diacrylate, pentaerythritol tetraacrylate, neopentyl glycol dimethacrylate, allyl methacrylate, allyl acrylate, butenyl acrylate, undecenyl methacrylate, 1,4-butanediol dimethacrylate, trimethylol propane trimethacrylate, trimethylol propane triacylate, 1,3-dibutanediol dimethacrylate, methylene-bisacrylamide, and hexamethylene-bisacrylamide), dienes (such as butadiene and isoprene), other divinyl compounds such as divinyl sulfide and divinyl sulfone compounds, and other compounds that would be readily apparent to one skilled in the art. Two or more of these monomers can be used to prepare matting agents. The polyfunctional acrylates and methacrylates described above are preferred in the practice of this invention. Ethylene glycol dimethacrylate, 1,6-hexanediol dimethacrylate, 1,6-hexanediol diacrylate, trimethylol propane trimethacrylate, and trimethylol propane triacrylate are particularly preferred. Ethylene glycol dimethacrylate is most preferred.

Ethylenically unsaturated monomers represented by (B) include polymerizable compounds that only one functional group that can be polymerized or reacted to form crosslinking sites within the polymer matrix. These include any other known monomer that can be polymerized in suspension polymerization with the monomers defined by the (A) recurring units. Such monomers include but are not limited to, ethylenically unsaturated hydrocarbons (such as ethylene, propylene, 1-butene, isobutene, styrene, α-methylstyrene, m-chloromethylstyrene, vinyl toluene, vinyl naphthalene, p-methoxystyrene, and hydroxymethylstyrene), ethylenically unsaturated esters of carboxylic acids (such as vinyl acetate, vinyl propionate, vinyl benzoate, vinyl cinnamate, and vinyl butyrate), esters of ethylenically unsaturated mono- or dicarboxylic acid amides (such as acrylamide, methacrylamide, N-methylacrylamide, N-ethylacrylamide, N,N-dimethylacrylamide, N-n-butylacrylamide, N-t-butylacrylamide, itaconic acid diamide, acrylamido-2,2-dimethylpropanesulfonic acid, N-isopropylacrylamide, N-acryloylmorpholine, and N-acryloylpiperidine), monoethylenically unsaturated dicarboxylic acids and their salts (such as acrylic acid, methacrylic acid, itaconic acid, and their salts), monoethylenically unsaturated compounds such as acrylonitrile and methacrylonitrile, vinyl halides (such as vinyl chloride, vinyl fluoride, and vinyl bromide), vinyl ethers (such as vinyl methyl ether, vinyl isobutyl ether, and vinyl ethyl ether), vinyl ketones (such as vinyl methyl ketone, vinyl hexyl ketone, and methyl isopropenyl ketone), acrolein, vinylidene halides (such as vinylidene chloride and vinylidene chlorofluoride), N-vinyl compounds (such as N-vinyl pyrrolidone, N-vinyl pyrrole, N-vinyl carbazole, and N-vinyl indole), and alkyl or aryl esters, amides, and nitriles (that is acrylates and methacrylates, such as methyl methacrylate, methyl acrylate, ethyl methacrylate, ethyl acrylate, n-butyl methacrylate, isobutyl methacrylate, 2-hydroxyethyl acrylate, 2-hydroxyethyl methacrylate, hexyl acrylate, hexyl methacrylate, 2-ethylhexyl acrylate, nonyl methacrylate, benzyl methacrylate, 2-hydroxypropyl methacrylate, and amides and nitriles of the same acids), and other compounds that would be understood to one skilled in the art. Mixtures of such monomers can also be used. Acrylates and methacrylates are preferred monomers for obtaining the (B) recurring units. Methyl methacrylate, isobutyl methacrylate, and methyl acrylate are particularly preferred and methyl methacrylate is most preferred.

In some embodiments, polymeric matting agents are prepared using one or more polyfunctional acrylates or methacrylates and one or more monofunctional acrylates or methacrylates. Representative useful polymers are as follows (having weight ratios within the previously described ranges): poly(methyl methacrylate-co-ethylene glycol dimethacrylate), poly(methyl methacrylate-co-1,6-hexanediol diacrylate), poly(methyl acrylate-co-trimethylol propane triacrylate), poly(isobutyl methacrylate-co-ethylene glycol dimethacrylate), and poly(methyl acrylate-co-1,6-hexanediol diacrylate).

### EXEMPLARY EMBODIMENTS

U.S. provisional application No. 61/490,615, filed May 27, 2011, entitled TRANSPARENT INK-JET RECORDING FILMS, COMPOSITIONS, AND METHODS, which is hereby incorporated by reference in its entirety, disclosed the following ten non-limiting exemplary embodiments:

A. A method comprising:

forming a first composition comprising gelatin;

forming a second composition comprising at least one borate or borate derivative and the first composition; and

forming a transparent ink-jet film by a method comprising forming an under-layer coating from the second composition.

B. The method according to embodiment A, wherein the at least one borate or borate derivative comprises at least one hydrate of sodium tetraborate.
C. The method according to embodiment A, wherein the at least one borate or borate derivative comprises sodium tetraborate decahydrate.
D. The method according to embodiment A, wherein the second composition further comprises at least one anionic polymer.
E. The method according to embodiment A, wherein the second composition further comprises polystyrene sulfonate.
F. The method according to embodiment A, wherein the method of forming a transparent ink-jet film further comprises:

forming an image-receiving layer coating mix comprising at least one inorganic particle and at least one water soluble or water dispersible polymer comprising at least one hydroxyl group; and

forming an image-receiving layer from the image-receiving layer coating mix.

G. A transparent ink-jet film prepared according to the method of embodiment A.
H. A method comprising:

forming a first composition comprising gelatin; forming a second composition comprising at least one borate or borate derivative and the first composition;

forming a third composition comprising at least one anionic polymer and the second composition; and

forming a transparent ink-jet film by a method comprising forming an under-layer coating from the third composition.

J. The method according to embodiment H, wherein the method of forming a transparent ink-jet film further comprises:

forming an image-receiving layer coating mix comprising at least one inorganic particle and at least one water soluble or water dispersible polymer comprising at least one hydroxyl group; and

forming an image-receiving layer from the image receiving layer coating mix.

K. A transparent ink-jet film prepared according to the method of embodiment H.

### EXAMPLES

### Materials

Materials used in the examples were available from Aldrich Chemical Co., Milwaukee, unless otherwise specified.

Boehmite is an aluminum oxide hydroxide (γ-AlO(OH)).

Borax is sodium tetraborate decahydrate.

CELVOL® 540 is a poly(vinyl alcohol) that is 87-89.9% hydrolyzed, with 140,000-186,000 weight-average molecular weight. It is available from Sekisui Specialty Chemicals America, LLC, Dallas, Tex.

DISPERAL® HP-14 is a dispersible boehmite alumina powder with high porosity and a particle size of 14 nm. It is available from Sasol North America, Inc., Houston, Tex.

Gelatin is a Regular Type IV bovine gelatin. It is available as Catalog No. 8256786 from Eastman Gelatine Corporation, Peabody, Mass.

KATHON® LX is a microbiocide. It is available from Dow Chemical.

Surfactant 10G is an aqueous solution of nonyl phenol, glycidyl polyether. It is available from Dixie Chemical Co., Houston, Tex.

VERSA-TL® 502 is a sulfonated polystyrene (1,000,000 molecular weight). It is available from AkzoNobel.

### Methods

### Evaluation of Samples for Drying

Coated films were imaged with either an EPSON® 4900 ink-jet printer or an EPSON® 7900 ink-jet printer using a Wasatch Raster Image Processor (RIP). A grey scale image was created by a combination of photo black, light black, light light black, magenta, light magenta, cyan, light cyan, and yellow EPSON inks that were supplied with the printer. Samples were printed with a 17-step grey scale wedge having a maximum optical density of at least 2.8. Films were evaluated under moderate humidity (50-60% relative humidity) and high humidity (80-90% relative humidity) conditions. Coated films were equilibrated at these conditions for at least 16 hrs prior to printing.

Immediately after the film exited the printer, the ink-jet image was turned over and placed over a piece of white paper. The fraction of each wedge that was wet was recorded by sequential wedge number, with wedge 1 being the wedge having the maximum optical density and wedge 17 being the wedge with the minimum optical density. In general, the higher number wedges dried before the lowest number wedges.

Measures of wetness were constructed by taking the largest wedge number for the set of completely wet wedges and adding to it the fractional wetness of the adjacent wedge with the next higher wedge number. For example, if wedges 1 and 2 were completely wet and wedge 3 was 25% wet, the wetness value would be 2.25. Or if no wedges were completely wet, but wedge 1 was 75% wet, the wetness value would be 0.75.

Maximum optical densities (Dmax) were measured from the highest-numbered wet wedges using a calibrated X-RITE DTP 41 spectrophotometer (X-Rite, Inc., Grandville, Mich.) in transmission mode.

### Example 1

### Preparation of Gelatin Under-Layer Coating Mix

To a mixing vessel, 258 parts by weight of deionized water was introduced. 12.6 parts of gelatin was added to the agitated vessel and allowed to swell. This mix was heated to 60° C. and held until the gelatin was fully dissolved. To this mix, 5.67 parts of borax (sodium tetraborate decahydrate) was added and mixed until the borax was fully dissolved. To this mix, 19.7 parts of an aqueous solution of 12 wt % sulfonated polystyrene (VERSA-TL® 502, AkzoNobel) and 0.2 wt % microbiocide (KATHON® LX, Dow) was added and mixed until homogeneous. 4.30 parts of a 10 wt % aqueous solution of nonyl phenol, glycidyl polyether (Surfactant 10G) was then added and mixed until homogeneous. This mix was cooled to room temperature and held to allow disengagement of any gas bubbles prior to use. The weight ratio of borax to gelatin in the resulting under-layer coating mix was 0.45:1.

### Preparation of Under-Layer Coated Substrates

7 mil polyethylene terephthalate substrates were knife-coated with 20.0 g each of the under-layer coating mix, heated to 40° C., using a wet coating gap of 3.5 mils. The under-layer coatings were air-dried at room temperature.

### Preparation of Poly(Vinyl Alcohol) Mix

A poly(vinyl alcohol) mix was prepared at room temperature by adding 25 parts by weight of poly(vinyl alcohol) (CELVOL® 540) to a mixing vessel containing 225 parts of deionized water over 10 min with 500 rpm agitation. This mixture was heated to 85° C. and agitated for 30 minutes. The mixture was then allowed to cool to room temperature. Demineralized water was added to make up for water lost due to evaporation.

### Preparation of Alumina Mix

An alumina mix was prepared at room temperature by mixing 4.62 parts by weight of a 22 wt % aqueous solution of nitric acid and 555.4 parts of demineralized water. To this mix, 140 parts of alumina powder (DISPERAL®HP-14) was added over 30 min. The pH of the mix was adjusted to 3.25 by adding additional nitric acid solution. The mix was heated to 80° C. and stirred for 30 min. The mix was cooled to room temperature and held for gas bubble disengagement prior to use.

### Preparation of Image-Receiving Layer Coating Mix

An image-receiving coating mix was prepared at room temperature by introducing 7.13 parts by weight of the 10 wt % aqueous solution of poly(vinyl alcohol) (CELVOL® 540) into a mixing vessel and agitating. To this mix, 41.0 parts of the alumina mix, 0.66 parts of a 10 wt % aqueous solution of nonyl phenol, glycidyl polyether (Surfactant 10G) and 1.00 parts of deionized water were added. The mix was cooled to room temperature and held for gas bubble disengagement prior to use.

### Preparation of Image-Receiving Layer Coated Film

The under-layer-coated substrates were knife-coated with 49.80 g each of the image-receiving layer coating mix, using a wet coating gap of 12.0 mils. The image-receiving layers were dried in an 80° C. BLUE-M® oven prior to use.

### Evaluation of Coated Films

Two drying evaluation trials were run on each of three image-receiving layer coated film samples (1-1, 1-2, 1-3), using an EPSON® 4900 ink-jet printer. The results of the film evaluations are shown in Table I.

### Example 2

The procedure according to Example 1 was repeated, except that the under-layer coating mix was prepared according to the following procedure. To a mixing vessel, 257 parts by weight of deionized water was introduced. 12.6 parts of gelatin was added to the agitated vessel and allowed to swell. This mix was heated to 60° C. and held until the gelatin was fully dissolved. To this mix, 6.72 parts of borax (sodium tetraborate decahydrate) was added and mixed until the borax was fully dissolved. To this mix, 19.7 parts of an aqueous solution of 3.2 wt % sulfonated polystyrene (VERSA-TL® 502, AkzoNobel) and 0.2 wt % microbiocide (KATHON® LX, Dow) was added and mixed until homogeneous. 4.30 parts of a 10 wt % aqueous solution of nonyl phenol, glycidyl polyether (Surfactant 10G) was then added and mixed until homogeneous. This mix was cooled to room temperature and held to allow disengagement of any gas bubbles prior to use. The weight ratio of borax to gelatin in the resulting under-layer coating mix was 0.53:1.

Two drying evaluation trials were run on image receiving layer coated film samples, the first sample 2-1 and the second on samples 2-1 and 2-2, using an EPSON® 4900 ink-jet printer. The results of the film evaluations are shown in Table I. These samples, which had higher borax to gelatin ratios than those of Example 1, showed improved drying performance compared to those of Example 1.

### Example 3

The procedure according to Example 1 was repeated, except that the under-layer coating mix was prepared according to the following procedure. To a mixing vessel, 256 parts by weight of deionized water was introduced. 12.6 parts of gelatin was added to the agitated vessel and allowed to swell. This mix was heated to 60° C. and held until the gelatin was fully dissolved. To this mix, 7.35 parts of borax (sodium tetraborate decahydrate) was added and mixed until the borax was fully dissolved. To this mix, 19.7 parts of an aqueous solution of 12 wt % sulfonated polystyrene (VERSA-TL® 502, AkzoNobel) and 0.2 wt % microbiocide (KATHON® LX, Dow) was added and mixed until homogeneous. 4.30 parts of a 10 wt % aqueous solution of nonyl phenol, glycidyl polyether (Surfactant 10G) was then added and mixed until homogeneous. This mix was cooled to room temperature and held to allow disengagement of any gas bubbles prior to use. The weight ratio of borax to gelatin in the resulting under-layer coating mix was 0.58:1.

Two drying evaluation trials were run on each of two image-receiving layer coated film samples (3-1, 3-2), using an EPSON® 4900 ink-jet printer. The results of the film evaluations are shown in Table I. These samples, which had higher borax to gelatin ratios than those of Example 1, showed improved drying performance compared to those of Example 1.

### Example 4

### Preparation of Gelatin Under-Layer Coating Mix

To a mixing vessel, 170.43 parts by weight of demineralized water was introduced. 8.40 parts of gelatin was added to the agitated vessel and allowed to swell. This mix was heated to 60° C. and held until the gelatin was fully dissolved. The mix was then cooled to 50° C. To this mix, 5.18 parts of borax (sodium tetraborate decahydrate) was added and mixed until the borax was fully dissolved. To this mix, 13.1 parts of an aqueous solution of 3.2 wt % sulfonated polystyrene (VERSA-TL® 502, AkzoNobel) and 0.2 wt % microbiocide (KATHON® LX, Dow) was added and mixed until homogeneous. The mix was then cooled to 40° C. 2.86 parts of a 10 wt % aqueous solution of nonyl phenol, glycidyl polyether (Surfactant 10G) was then added and mixed until homogeneous. This mix was cooled to room temperature and held to allow disengagement of any gas bubbles prior to use. The weight ratio of borax to gelatin in the resulting under-layer coating mix was 0.62:1.

### Preparation of Under-Layer Coated Webs

The under-layer coating mix was heated to 40° C. and applied continuously to polyethylene terephthalate webs, which were moving at a speed of 40 ft/min. The under-layer coating mix feed rate was 66 g/m², resulting in a dry under-layer coating weight of 4.3 g/m². The coated webs were dried continuously by moving past perforated plates through which room temperature air flowed. The pressure drop across the perforated plates was in the range of 0.8 to 3 in H₂O. The air dew point was in the range of 7 to 13° C.

### Preparation of Poly(Vinyl Alcohol) Mix

A poly(vinyl alcohol) mix was prepared at room temperature by adding 400 parts by weight of poly(vinyl alcohol) (CELVOL® 540) to a mixing vessel containing 3600 parts of demineralized water over 10 min with 500 rpm agitation. This mixture was heated to 85° C. and agitated for 30 minutes. The mixture was then allowed to cool to room temperature. Demineralized water was added to make up for water lost due to evaporation.

### Preparation of Alumina Mix

An alumina mix was prepared at room temperature by mixing 166 parts by weight of a 22 wt % aqueous solution of nitric acid and 6059 parts of demineralized water. To this mix, 2075 parts of alumina powder (DISPERAL® HP-14) was added over 30 min. The pH of the mix was adjusted to 2.56 by adding additional nitric acid solution. The mix was heated to 80° C. and stirred for 30 min. The mix was cooled to room temperature and held for gas bubble disengagement prior to use.

### Preparation of Image-Receiving Layer Coating Mix

An image-receiving coating mix was prepared at room temperature by introducing 1756 parts by weight of the 10 wt % aqueous solution of poly(vinyl alcohol) (CELVOL® 540) into a mixing vessel and agitating. To this mix, 8080 parts of the alumina mix and 163 parts of a 10 wt % aqueous solution of nonyl phenol, glycidyl polyether (Surfactant 10G) were added. The mix was cooled to room temperature and held for gas bubble disengagement prior to use.

### Preparation of Image-Receiving Layer Coated Film

The image-coating mix was heated to 40° C. and coated onto the under-layer coated surface of a room temperature polyethylene terephthalate web, which was moving at a speed of 30 ft/min. The image-receiving layer coating mix feed rate was 199 g/m², resulting in a dry image-receiving layer coating weight of 46.1 g/m². The coated film was dried continuously by moving past perforated plates through which room temperature air flowed. The pressure drop across the perforated plates was in the range of 0.8 to 3 in H₂O. The air dew point was in the range of 7 to 13° C.

### Evaluation of Coated Films

Two drying evaluation trials were run on samples cut from the image-receiving layer coated film, using an EPSON® 4900 ink-jet printer. The results of the film evaluation are shown in Table II.

### Example 5

The procedure according to Example 4 was repeated, except that the under-layer coating feed rate was reduced to 48 g/m². The resulting dry under-layer coating weight was 3.1 g/m² and the dry image-receiving layer coating weight was 46.4 g/m².

Two drying evaluation trials were run on samples cut from the image-receiving layer coated film, using an EPSON® 4900 ink-jet printer. The results of the film evaluation are shown in Table II. This sample, which had a lower under-layer coating weight than that of Example 4, showed worsened high humidity drying performance compared to that of Example 4.

### Example 6

The procedure according to Example 1 was repeated, except that the under-layer coating mix was prepared according to the following procedure. To a mixing vessel, 171.83 parts by weight of demineralized water was introduced. 8.40 parts of gelatin was added to the agitated vessel and allowed to swell. This mix was heated to 60° C. and held until the gelatin was fully dissolved. The mix was then cooled to 50° C. To this mix, 3.78 parts of borax (sodium tetraborate decahydrate) was added and mixed until the borax was fully dissolved. To this mix, 13.1 parts of an aqueous solution of 3.2 wt % sulfonated polystyrene (VERSA-TL® 502, AkzoNobel) and 0.2 wt % microbiocide (KATHON® LX, Dow) was added and mixed until homogeneous. The mix was then cooled to 40° C. 2.86 parts of a 10 wt % aqueous solution of nonyl phenol, glycidyl polyether (Surfactant 10G) was then added and mixed until homogeneous. This mix was cooled to room temperature and held to allow disengagement of any gas bubbles prior to use. The weight ratio of borax to gelatin in the resulting under-layer coating mix was 0.45:1. The resulting dry under-layer coating weight was 3.9 g/m² and the dry image-receiving layer coating weight was 46.5 g/m².

Two drying evaluation trials were run on image-receiving layer coated film samples, using an EPSON® 4900 ink-jet printer. The results of the film evaluation are shown in Table II. These samples, which had lower borax to gelatin ratios than those of Examples 4 and 5, showed worsened drying performance compared to those of Examples 4 and 5.

### Example 7

### Preparation of Gelatin Under-Layer Coating Mix

To a mixing vessel, 132 parts by weight of deionized water and 132 parts of a 4.3 wt % aqueous solution of borax (sodium tetraborate decahydrate) were introduced and mixed at room temperature. To this mixture, 12.6 parts of gelatin was added with agitation and allowed to mix for 15 min. This mix was heated to 60° C. and held until the gelatin was fully dissolved. To this mix, 16.7 parts of an aqueous solution of 3.2 wt % sulfonated polystyrene (VERSA-TL® 502, AkzoNobel) and 0.2 wt % microbiocide (KATHON® LX, Dow) was added and mixed until homogeneous. 4.30 parts of a 10 wt % aqueous solution of nonyl phenol, glycidyl polyether (Surfactant 10G) was then added and mixed for 5 min. This mix was cooled to room temperature and held to allow disengagement of any gas bubbles prior to use. The weight ratio of borax to gelatin in the resulting under-layer coating mix was 0.45:1.

### Preparation of Under-Layer Coated Substrates

7 mil polyethylene terephthalate substrates were knife-coated with 20.0 g each of the under-layer coating mix, heated to 40° C., using a wet coating gap of 4.0 mils. The under-layer coatings were air-dried at room temperature.

### Preparation of Poly(Vinyl Alcohol) Mix

A poly(vinyl alcohol) mix was prepared at room temperature by adding 25 parts by weight of poly(vinyl alcohol) (CELVOL® 540) to a mixing vessel containing 225 parts of deionized water over 10 min with 500 rpm agitation. This mixture was heated to 85° C. and agitated for 30 minutes. The mixture was then allowed to cool to room temperature. Demineralized water was added to make up for water lost due to evaporation.

### Preparation of Alumina Mix

An alumina mix was prepared at room temperature by mixing 3.6 parts by weight of a 22 wt % aqueous solution of nitric acid and 556 parts of demineralized water. To this mix, 140 parts of alumina powder (DISPERAL® HP-14) was added over 30 min. The pH of the mix was adjusted to 3.25 by adding additional nitric acid solution. The mix was heated to 80° C. and stirred for 30 min. The mix was cooled to room temperature and held for gas bubble disengagement prior to use.

### Preparation of Image-Receiving Layer Coating Mix

An image-receiving coating mix was prepared at room temperature by introducing 7.13 parts by weight of the 10 wt % aqueous solution of poly(vinyl alcohol) (CELVOL® 540) into a mixing vessel and agitating. To this mix, 41.0 parts of the alumina mix, 0.66 parts of a 10 wt % aqueous solution of nonyl phenol, glycidyl polyether (Surfactant 10G) and 1.00 parts of deionized water were added. The mix was cooled to room temperature and held for gas bubble disengagement prior to use.

### Preparation of Image-Receiving Layer Coated Film

The under-layer-coated substrates were knife-coated with 49.80 g each of the image-receiving layer coating mix, using a wet coating gap of 12.0 mils. The image-receiving layers were dried in a 50° C. BLUE-M^{c}) oven prior to use.

### Evaluation of Coated Films

Drying evaluation trials were run on each of two image-receiving layer coated film samples (7-1 and 7-2), using an EPSON® 4900 ink-jet printer. The results of the film evaluations are shown in Table III.

### Example 8

### Preparation of Gelatin Under-Layer Coating Mix

To a mixing vessel, 68.1 parts by weight of deionized water and 195 parts of a 4.3 wt % aqueous solution of borax (sodium tetraborate decahydrate) were introduced and mixed at room temperature. To this mixture, 12.6 parts of gelatin was added with agitation and allowed to mix for 15 min. This mix was heated to 60° C. and held until the gelatin was fully dissolved. To this mix, 19.7 parts of an aqueous solution of 3.2 wt % sulfonated polystyrene (VERSA-TL® 502, AkzoNobel) and 0.2 wt % microbiocide (KATHON® LX, Dow) was added and mixed until homogeneous. 4.30 parts of a 10 wt % aqueous solution of nonyl phenol, glycidyl polyether (Surfactant 10G) was then added and mixed for 5 min. This mix was cooled to room temperature and held to allow disengagement of any gas bubbles prior to use. The weight ratio of borax to gelatin in the resulting under-layer coating mix was 0.67:1.

### Preparation of Under-Layer Coated Substrates

7 mil polyethylene terephthalate substrates were knife-coated with 20.0 g each of the under-layer coating mix, heated to 40° C., using a wet coating gap of 4.0 mils for Sample 8-1 and 3.5 mils for Samples 8-2 and 8-3. The under-layer coatings were air-dried at room temperature.

### Preparation of Image-Receiving Layer Coated Film

An image-receiving layer coating mix was prepared according to the procedure of Example 7. The under-layer-coated substrates were knife-coated with 49.80 g each of the image-receiving layer coating mix, using a wet coating gap of 12.0 mils. The image-receiving layers were dried in a 50° C. BLUE-M® oven prior to use.

### Evaluation of Coated Films

Drying evaluation trials were run on each of three image-receiving layer coated film samples (8-1, 8-2, and 8-3), using an EPSON® 4900 ink-jet printer. The results of the film evaluations are shown in Table III. Sample 8-1 had higher borax to gelatin ratios than Samples 7-1 and 8-2, but its drying performance was worse. Samples 8-2 and 8-3 had dry borax coverages similar to those of Samples 7-1 and 7-2, but showed worsened drying performance.

### Example 9

### Preparation of Gelatin Under-Layer Coating Mix

To a mixing vessel, 10.9 parts by weight of deionized water and 252 parts of a 4.3 wt % aqueous solution of borax (sodium tetraborate decahydrate) were introduced and mixed at room temperature. To this mixture, 12.6 parts of gelatin was added with agitation and allowed to mix for 15 min. This mix was heated to 60° C. and held until the gelatin was fully dissolved. To this mix, 19.7 parts of an aqueous solution of 3.2 wt % sulfonated polystyrene (VERSA-TL® 502, AkzoNobel) and 0.2 wt % microbiocide (KATHON® LX, Dow) was added and mixed until homogeneous. 4.30 parts of a 10 wt % aqueous solution of nonyl phenol, glycidyl polyether (Surfactant 10G) was then added and mixed for 5 min. This mix was cooled to room temperature and held to allow disengagement of any gas bubbles prior to use. The weight ratio of borax to gelatin in the resulting under-layer coating mix was 0.86:1.

### Preparation of Under-layer Coated Substrates

7 mil polyethylene terephthalate substrates were knife-coated with 20.0 g each of the under-layer coating mix, heated to 40° C., using a wet coating gap of 4.0 mils for Sample 9-1 and 3.2 mils for Samples 9-2 and 9-3. The under-layer coatings were air-dried at room temperature.

### Preparation of Image-Receiving Layer Coated Film

An image-receiving layer coating mix was prepared according to the procedure of Example 7. The under-layer-coated substrates were knife-coated with 49.80 g each of the image-receiving layer coating mix, using a wet coating gap of 12.0 mils. The image-receiving layers were dried in a 50° C. BLUE-M® oven prior to use.

### Evaluation of Coated Films

Drying evaluation trials were run on each of three image-receiving layer coated film samples (9-1, 9-2, and 9-3), using an EPSON® 4900 ink-jet printer. The results of the film evaluations are shown in Table III. Sample 9-1 had higher borax to gelatin ratios than Samples 7-1, 7-2, and 8-1, but its drying performance was worse. Samples 9-2 and 9-3 had dry borax coverages similar to those of Samples 7-1, 7-2, 8-2, and 8-3, but showed worsened drying performance.

### Example 10

### Preparation of Gelatin Under-Layer Coating Mix

To a mixing vessel, 240 parts by weight of deionized water was introduced. 18.0 parts of gelatin was added to the agitated vessel and allowed to swell. This mix was heated to 60° C. and held until the gelatin was fully dissolved. To this mix, 8.10 parts of borax (sodium tetraborate decahydrate) was added and mixed for 15 min. To this mix, 28.1 parts of an aqueous solution of 3.2 wt % sulfonated polystyrene (VERSA-TL® 502, AkzoNobel) and 0.2 wt % microbiocide (KATHON® LX, Dow) was added and mixed for 15 min. 6.14 parts of a 10 wt % aqueous solution of nonyl phenol, glycidyl polyether (Surfactant 10G) was then added and mixed until homogeneous. This mix was cooled to room temperature and held to allow disengagement of any gas bubbles prior to use. The weight ratio of borax to gelatin in the resulting under-layer coating mix was 0.45:1.

### Preparation of Under-Layer Coated Substrates

7 mil polyethylene terephthalate substrates were knife-coated with 20.0 g each of the under-layer coating mix, heated to 40° C., using a wet coating gap of 3.0 mils. The under-layer coatings were air-dried at room temperature.

### Preparation of Poly(Vinyl Alcohol) Mix

A poly(vinyl alcohol) mix was prepared at room temperature by adding 25 parts by weight of poly(vinyl alcohol) (CELVOL® 540) to a mixing vessel containing 225 parts of deionized water over 10 min with 500 rpm agitation. This mixture was heated to 85° C. and agitated for 30 minutes. The mixture was then allowed to cool to room temperature. Demineralized water was added to make up for water lost due to evaporation.

### Preparation of Alumina Mix

An alumina mix was prepared at room temperature by mixing 3.6 parts by weight of a 22 wt % aqueous solution of nitric acid and 556 parts of demineralized water. To this mix, 140 parts of alumina powder (DISPERAL® HP-14) was added over 30 min. The pH of the mix was adjusted to 3.25 by adding additional nitric acid solution. The mix was heated to 80° C. and stirred for 30 min. The mix was cooled to room temperature and held for gas bubble disengagement prior to use.

### Preparation of Image-Receiving Layer Coating Mix

An image-receiving coating mix was prepared at room temperature by introducing 7.13 parts by weight of the 10 wt % aqueous solution of poly(vinyl alcohol) (CELVOL® 540) into a mixing vessel and agitating. To this mix, 41.0 parts of the alumina mix, 0.66 parts of a 10 wt % aqueous solution of nonyl phenol, glycidyl polyether (Surfactant 10G) and 1.00 parts of deionized water were added. The mix was cooled to room temperature and held for gas bubble disengagement prior to use.

### Preparation of Image-Receiving Layer Coated Film

The under-layer-coated substrates were knife-coated with 49.80 g each of the image-receiving layer coating mix, using a wet coating gap of 12.0 mils. The image-receiving layers were dried in a 50° C. BLUE-M® oven prior to use.

### Evaluation of Coated Films

Drying evaluation trials were run on two image-receiving layer coated film samples (10-1 and 10-2), using an EPSON® 4900 ink-jet printer. The results of the film evaluations are shown in Table IV.

### Example 11

The procedure according to Example 1 was repeated, except that the under-layer coating mix was prepared according to the following procedure. To a mixing vessel, 59.4 parts by weight of deionized water and 188 parts of a 4.3 wt % aqueous solution of borax (sodium tetraborate decahydrate) were introduced and mixed at room temperature. To this mixture, 18.0 parts of gelatin was added with agitation and allowed to mix for 15 min. This mix was heated to 60° C. and held until the gelatin was fully dissolved. To this mix, 28.1 parts of an aqueous solution of 3.2 wt % sulfonated polystyrene (VERSA-TL® 502, AkzoNobel) and 0.2 wt % microbiocide (KATHON® LX, Dow) was added and mixed for 15 min. 6.14 parts of a 10 wt % aqueous solution of nonyl phenol, glycidyl polyether (Surfactant 10G) was then added and mixed for 5 min. This mix was cooled to room temperature and held to allow disengagement of any gas bubbles prior to use. The weight ratio of borax to gelatin in the resulting under-layer coating mix was 0.45:1.

Drying evaluation trials were run on two image-receiving layer coated film samples (11-1 and 11-2), using an EPSON® 4900 ink-jet printer. The results of the film evaluations are shown in Table IV.

### Example 12

The procedure according to Example 10 was repeated, except that the under-layer coating mix was prepared according to the following procedure. To a mixing vessel, 10.2 parts by weight of deionized water and 238 parts of a 4.3 wt % aqueous solution of borax (sodium tetraborate decahydrate) were introduced and mixed at room temperature. To this mixture, 18.0 parts of gelatin was added with agitation and allowed to mix for 15 min. This mix was heated to 60° C. and held until the gelatin was fully dissolved. To this mix, 28.1 parts of an aqueous solution of 3.2 wt % sulfonated polystyrene (VERSA-TL® 502, AkzoNobel) and 0.2 wt % microbiocide (KATHON® LX, Dow) was added and mixed for 15 min. 6.14 parts of a 10 wt % aqueous solution of nonyl phenol, glycidyl polyether (Surfactant 10G) was then added and mixed for 5 min. This mix was cooled to room temperature and held to allow disengagement of any gas bubbles prior to use. The weight ratio of borax to gelatin in the resulting under-layer coating mix was 0.57:1.

Drying evaluation trials were run on two image-receiving layer coated film samples (12-1 and 12-2), using an EPSON® 4900 ink-jet printer. The results of the film evaluations are shown in Table IV. Note that for samples where borax was added before the gelatin, increasing the weight ratio of borax to gelatin resulted in worsened drying performance (compare average wetness of Samples 12-1 and 12-2 to average wetness of Samples 10-2, 11-1, and 11-2).

### Example 13

The procedure according to Example 10 was repeated, except that the under-layer coated substrates were prepared according to the following procedure. To a mixing vessel, 10.7 parts by weight of deionized water and 248 parts of a 4.3 wt % aqueous solution of borax (sodium tetraborate decahydrate) were introduced and mixed at room temperature. To this mixture, 18.0 parts of gelatin was added with agitation and allowed to mix for 15 min. This mix was heated to 60° C. and held until the gelatin was fully dissolved. To this mix, 16.9 parts of an aqueous solution of 3.2 wt % sulfonated polystyrene (VERSA-TL® 502, AkzoNobel) and 0.2 wt % microbiocide (KATHON® LX, Dow) was added and mixed for 15 min. 6.14 parts of a 10 wt % aqueous solution of nonyl phenol, glycidyl polyether (Surfactant 10G) was then added and mixed for 5 min. This mix was cooled to room temperature and held to allow disengagement of any gas bubbles prior to use. The weight ratio of borax to gelatin in the resulting under-layer coating mix was 0.59:1. 7 mil polyethylene terephthalate substrates were knife-coated with 20.0 g each of the under-layer coating mix, heated to 40° C., using a wet coating gap of 3.2 mils. The under-layer coatings were air-dried at room temperature.

Drying evaluation trials were run on two image-receiving layer coated film samples (13-1 and 13-2), using an EPSON® 4900 ink-jet printer. The results of the film evaluations are shown in Table IV. Note that for samples where borax was added before the gelatin, increasing the weight ratio of borax to gelatin resulted in worsened drying performance (compare average wetness of Samples 13-1 and 13-2 to average wetness of Samples 12-1 and 12-2 and to average wetness of Samples 10-2, 11-1, and 11-2).

### Example 14

The procedure according to Example 1 was repeated. The under-layer coating mix comprised 0.30 wt % of the sulfonated polystyrene and microbiocide aqueous solution on a dry basis. The under-layer coating mix, heated to 40° C., was knife-coated using wet coating gaps of 3.5 mils and 4.0 mils. The resulting dry under-layer coating weights were 3.4 and 4.0 g/m², respectively.

Drying evaluation trials were run on three image-receiving layer coated film samples (14-1, 14-2 and 14-3), using an EPSON 4900® ink-jet printer. The results of the film evaluations are shown in Table V.

### Example 15

The procedure according to Example 1 was repeated, except that the under-layer coating mix was prepared according to the following procedure. To a mixing vessel, 262 parts by weight of deionized water was introduced. 12.6 parts of gelatin was added to the agitated vessel and allowed to swell. This mix was heated to 60° C. and held until the gelatin was fully dissolved. To this mix, 5.67 parts of borax (sodium tetraborate decahydrate) was added and mixed for 15 minutes. To this mix, 15.8 parts of an aqueous solution of 3.2 wt % sulfonated polystyrene (VERSA-TL® 502, AkzoNobel) and 0.2 wt % microbiocide (KATHON® LX, Dow) was added and mixed for 15 minutes. 4.30 parts of a 10 wt % aqueous solution of nonyl phenol, glycidyl polyether (Surfactant 10G) was then added and mixed until homogeneous. This mix was cooled to room temperature and held to allow disengagement of any gas bubbles prior to use. The weight ratio of borax to gelatin in the resulting under-layer coating mix was 0.45:1. The under-layer coating mix comprised 0.24 wt % of the sulfonated polystyrene and microbiocide aqueous solution on a dry basis. The under-layer coating mix, heated to 40° C., was knife-coated using wet coating gaps of 3.5 mils and 4.0 mils. The resulting dry under-layer coating weight was 3.2 and 3.8 g/m², respectively.

Drying evaluation trials were run on two image-receiving layer coated film samples (15-1 and 15-2), using an EPSON® 4900 ink-jet printer. The results of the film evaluations are shown in Table V.

### Example 16

The procedure according to Example 1 was repeated, except that the under-layer coating mix was prepared according to the following procedure. To a mixing vessel, 266 parts by weight of deionized water was introduced. 12.6 parts of gelatin was added to the agitated vessel and allowed to swell. This mix was heated to 60° C. and held until the gelatin was fully dissolved. To this mix, 5.67 parts of borax (sodium tetraborate decahydrate) was added and mixed for 15 minutes. To this mix, 11.8 parts of an aqueous solution of 3.2 wt % sulfonated polystyrene (VERSA-TL® 502, AkzoNobel) and 0.2 wt % microbiocide (KATHON® LX, Dow) was added and mixed for 15 minutes. 4.30 parts of a 10 wt % aqueous solution of nonyl phenol, glycidyl polyether (Surfactant 10G) was then added and mixed until homogeneous. This mix was cooled to room temperature and held to allow disengagement of any gas bubbles prior to use. The weight ratio of borax to gelatin in the resulting under-layer coating mix was 0.45:1. The under-layer comprised 0.18 wt % of the sulfonated polystyrene and microbiocide aqueous solution on a dry basis. The under-layer coating mix, heated to 40° C., was knife-coated using wet coating gaps of 3.5 mils and 4.0 mils. The resulting dry under-layer coating weights were 3.0 and 3.6 g/m², respectively.

Drying evaluation trials were run on two image-receiving layer coated film samples (16-1 and 16-2), using an EPSON® 4900 ink-jet printer. The results of the film evaluations are shown in Table V. Note as the dry loading of the sulfonated polystyrene and microbiocide aqueous solution in the under-layer decreased, no effect on the drying performance was observed (compare average wetness of Samples 14-1 and 14-3 to average wetness of Sample 15-1 and of Sample 16-1; and compare average wetness of Sample 14-2 to average wetness of Sample 15-2 and of Sample 16-2).

### Example 17

The procedure according to Example 10 was repeated. The under-layer coating mix comprised 0.30 wt % of the sulfonated polystyrene and microbiocide aqueous solution on a dry basis. The under-layer coating mix, heated to 40° C., was knife-coated using wet coating gaps of 3.1 mils and 4.0 mils. The resulting dry under-layer coating weights were 4.0 and 5.3 g/m², respectively.

Drying evaluation trials were run on three image-receiving layer coated film samples (17-1, 17-2 and 17-3), using an EPSON® 4900 ink-jet printer. The results of the film evaluations are shown in Table VI.

### Example 18

The procedure according to Example 10 was repeated, except that the under-layer coating mix was prepared according to the following procedure. To a mixing vessel, 240 parts by weight of deionized water was introduced. 18.0 parts of gelatin was added to the agitated vessel and allowed to swell. This mix was heated to 60° C. and held until the gelatin was fully dissolved. To this mix, 28.1 parts of an aqueous solution of 3.2 wt % sulfonated polystyrene (VERSA-TL® 502, AkzoNobel) and 0.2 wt % microbiocide (KATHON® LX, Dow) was added and mixed for 10 minutes. To this mix, 8.10 parts of borax (sodium tetraborate decahydrate) was added and mixed for 10 minutes. 4.30 parts of a 10 wt % aqueous solution of nonyl phenol, glycidyl polyether (Surfactant 10G) was then added and mixed until homogeneous. This mix was cooled to room temperature and held to allow disengagement of any gas bubbles prior to use. The weight ratio of borax to gelatin in the resulting under-layer coating mix was 0.45:1. The under-layer coating mix comprised 0.30 wt % of the sulfonated polystyrene and microbiocide aqueous solution on a dry basis. The under-layer coating mix, heated to 40° C., was knife-coated using a wet coating gap of 3.1 mils or 4.0 mils. The resulting dry under-layer coating weight was 4.0 and 5.3 g/m², respectively.

Drying evaluation trials were run on three image-receiving layer coated film samples (18-1, 18-2 and 18-3), using an EPSON® 4900 ink-jet printer. The results of the film evaluations are shown in Table VI. Note the order of addition for the borax either before or after the sulfonated polystyrene and microbiocide solution in the under-layer mix melt had no effect on the observed drying performance (compare average wetness of Samples 17-1 and 17-2 to average wetness of Samples 18-1 and 18-2; and compare average wetness of Sample 17-3 to average wetness of Sample 18-3).

The invention has been described in detail with reference to particular embodiments, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

TABLE I

| | | | Under-Layer | | |
|---|---|---|---|---|---|
| TRIAL | SAMPLE | MODE | Borax:Gelatin | Dmax | Wetness |
| 1 | 1-1 | Borax late | 0.45:1 | 2.90 | 1.75 |
| 1 | 1-2 | Borax late | 0.45:1 | 2.79 | 2.75 |
| 1 | 1-3 | Borax late | 0.45:1 | 2.82 | 1.75 |
| 1 | 2-1 | Borax late | 0.53:1 | 2.84 | 1.5 |
| 1 | 3-1 | Borax late | 0.58:1 | 2.88 | 1.125 |
| 1 | 3-2 | Borax late | 0.58:1 | 2.90 | 1.125 |
| 2 | 1-1 | Borax late | 0.45:1 | 2.78 | 2.75 |
| 2 | 1-2 | Borax late | 0.45:1 | 2.86 | 3.00 |
| 2 | 1-3 | Borax late | 0.45:1 | 2.79 | 3.00 |
| 2 | 2-1 | Borax late | 0.53:1 | 2.88 | 1.875 |
| 2 | 2-2 | Borax late | 0.53:1 | 2.96 | 1.25 |
| 2 | 3-1 | Borax late | 0.58:1 | 2.93 | 1.75 |
| 2 | 3-2 | Borax late | 0.58:1 | 2.90 | 1.875 |

Notes:
1. Tested at 86-89% relative humidity using an EPSON ® 4900 ink-jet printer.
2. 3.5 mil under-layer coating gap, 12.0 mil image-receiving layer coating gap.
3. Dmax measured on highest numbered wet wedge.

TABLE II

| | | | | Under- | | | |
|---|---|---|---|---|---|---|---|
| | | | | Layer | | | |
| | | | | Coating | | | |
| | | | Under- | Weight | | | |
| | | | Layer | (g/sq | Relative | | |
| TRIAL | SAMPLE | MODE | Borax:Gelatin | m) | Humidity | Dmax | Wetness |
| 1 | 4 | Borax | 0.62:1 | 4.3 | 86-88% | 3.06 | 0.125 |
| | | Late | | | | | |
| 1 | 5 | Borax | 0.62:1 | 3.1 | 86-88% | 2.90 | 0.25 |
| | | Late | | | | | |
| 1 | 6 | Borax | 0.45:1 | 3.9 | 86-88% | 2.88 | 0.25 |
| | | Late | | | | | |
| 2 | 4 | Borax | 0.62:1 | 4.3 | 57-58% | 3.12 | 0-0.125 |
| | | Late | | | | | |
| 2 | 5 | Borax | 0.62:1 | 3.1 | 57-58% | 3.20 | 0-0.125 |
| | | Late | | | | | |
| 2 | 6 | Borax | 0.45:1 | 3.9 | 57-58% | 3.18 | 0.125 |
| | | Late | | | | | |

Notes:
1. Tested using an EPSON ® 7900 ink-jet printer.
2. Dmax measured on highest numbered wet wedge.

TABLE III

| | | | Under- | Under- | | |
|---|---|---|---|---|---|---|
| | | | Layer | Layer | | |
| | | Under- | Coating | Coating | | |
| | | Layer | Gap | Mix | | Wet- |
| SAMPLE | MODE | Borax:Gelatin | (mils) | Solids | Dmax | ness |
| 7-1 | Borax | 0.45:1 | 4.0 | 6.4% | 3.00 | 0.50 |
| | Early | | | | | |
| 7-2 | Borax | 0.45:1 | 4.0 | 6.4% | 3.04 | 0.75 |
| | Early | | | | | |
| 8-1 | Borax | 0.67:1 | 4.0 | 7.4% | 2.91 | 1.75 |
| | Early | | | | | |
| 8-2 | Borax | 0.67:1 | 3.5 | 7.4% | 2.95 | 1.50 |
| | Early | | | | | |
| 8-3 | Borax | 0.67:1 | 3.5 | 7.4% | 2.94 | 1.50 |
| | Early | | | | | |
| 9-1 | Borax | 0.86:1 | 4.0 | 8.2% | 2.85 | 2.75 |
| | Early | | | | | |
| 9-2 | Borax | 0.86:1 | 3.2 | 8.2% | 2.92 | 1.75 |
| | Early | | | | | |
| 9-3 | Borax | 0.86:1 | 3.2 | 8.2% | 2.96 | 2.50 |
| | Early | | | | | |

Notes:
1. Tested at 86% relative humidity using an EPSON ® 4900 ink-jet printer.
2. Dmax measured on highest numbered wet wedge.

TABLE IV

| | | | Under- | Under- | | |
|---|---|---|---|---|---|---|
| | | | Layer | Layer | | |
| | | Under- | Coating | Coating | | |
| | | Layer | Gap | Mix | | Wet- |
| SAMPLE | MODE | Borax:Gelatin | (mils) | Solids | Dmax | ness |
| 10-1 | Borax | 0.45:1 | 3.0 | 9.20% | 2.99 | 0.75 |
| | Late | | | | | |
| 10-2 | Borax | 0.45:1 | 3.0 | 9.20% | 2.98 | 0.75 |
| | Early | | | | | |
| 11-1 | Borax | 0.45:1 | 3.0 | 9.20% | 2.97 | 0.75 |
| | Early | | | | | |
| 11-2 | Borax | 0.45:1 | 3.0 | 9.20% | 3.02 | 0.75 |
| | Early | | | | | |
| 12-1 | Borax | 0.57:1 | 3.0 | 9.91% | 3.02 | 0.75 |
| | Early | | | | | |
| 12-2 | Borax | 0.57:1 | 3.0 | 9.91% | 2.87 | 1.50 |
| | Early | | | | | |
| 13-1 | Borax | 0.59:1 | 3.2 | 9.95% | 2.88 | 1.50 |
| | Early | | | | | |
| 13-2 | Borax | 0.59:1 | 3.2 | 9.95% | 2.85 | 1.75 |
| | Early | | | | | |

Notes:
1. Tested at 84-85% relative humidity using an EPSON ® 4900 ink-jet printer.
2. Dmax measured on highest numbered wet wedge.

TABLE V

| | | VERSA- | | | | |
|---|---|---|---|---|---|---|
| | | TL Soln. | | | | |
| | | in | | | | |
| | | Under- | Under- | Under- | | |
| | | Layer | Layer | Layer | | |
| | | (wt %, | Coating | Coating | | |
| | | dry | Gap | Weight | | |
| SAMPLE | MODE | basis) | (mils) | (g/sq m) | Dmax | Wetness |
| 14-1 | Borax | 0.30 | 3.5 | 3.4 | 3.06 | 1.50 |
| | Late | | | | | |
| 14-2 | Borax | 0.30 | 4.0 | 4.0 | 3.09 | 1.50 |
| | Late | | | | | |
| 14-3 | Borax | 0.30 | 3.5 | 3.4 | 3.16 | 1.50 |
| | Late | | | | | |
| 15-1 | Borax | 0.24 | 3.5 | 3.2 | 3.14 | 1.75 |
| | Late | | | | | |
| 15-2 | Borax | 0.24 | 4.0 | 3.8 | 3.10 | 1.50 |
| | Late | | | | | |
| 16-1 | Borax | 0.18 | 3.5 | 3.0 | 3.08 | 0.75, 0.50 |
| | Late | | | | | |
| 16-2 | Borax | 0.18 | 4.0 | 3.6 | 3.13 | 1.50 |
| | Late | | | | | |

Notes:
1. Tested at 77-78% relative humidity using an EPSON ® 4900 ink-jet printer.
2. Under-layer Borax:Gelatin Ratio at 0.45:1.
3. Dmax measured on highest numbered wet wedge.
4. Sample 16-1 showed 0.75 wetness on highest density and 0.50 wetness on second highest density.

TABLE VI

| | | | Under- | Under- | | |
|---|---|---|---|---|---|---|
| | | | Layer | Layer | | |
| | ORDER | | Coating | Coating | | |
| | OF | | Gap | Weight | | |
| SAMPLE | ADDN. | MODE | (mils) | (g/sq m) | Dmax | Wetness |
| 17-1 | Borax/ | Borax | 3.1 | 4.0 | 2.94 | 0.125 |
| | VERSA- | Late | | | | |
| | TL | | | | | |
| 17-2 | Borax/ | Borax | 3.1 | 4.0 | 3.00 | 0.125 |
| | VERSA- | Late | | | | |
| | TL | | | | | |
| 17-3 | Borax/ | Borax | 4.0 | 5.3 | 2.96 | 0.125 |
| | VERSA- | Late | | | | |
| | TL | | | | | |
| 18-1 | VERSA- | Borax | 3.1 | 4.0 | 3.01 | 0.125 |
| | TL/Borax | Late | | | | |
| 18-2 | VERSA- | Borax | 3.1 | 4.0 | 2.97 | 0.125 |
| | TL/Borax | Late | | | | |
| 18-3 | VERSA- | Borax | 4.0 | 5.3 | 2.96 | 0.125 |
| | TL/Borax | Late | | | | |

Notes:
1. Tested at 84-87% relative humidity using an EPSON ® 4900 ink-jet printer.
2. Under-layer Borax:Gelatin Ratio at 0.45:1.
3. Dmax measured on highest numbered wet wedge.

What is claimed:

1. A method comprising:
forming a first composition comprising gelatin;
forming a second composition by a first method comprising adding at least one borate or borate derivative to the first composition, the second composition comprising at least one anionic polymer; and
forming a transparent ink-jet recording film by a second method comprising forming at least one under-layer from the second composition.

2. The method according to claim 1, wherein the second method further comprises:
forming a third composition comprising at least one inorganic particle and at least one water soluble or water dispersible polymer comprising at least one hydroxyl group; and
forming at least one image-receiving layer from the third composition, the at least one image-receiving layer being disposed on the at least one under-layer.

3. The method according to claim 2, wherein the at least one inorganic particle comprises boehmite alumina.

4. The method according to claim 2, wherein the at least one water soluble or water dispersible polymer comprises polyvinyl alcohol.

5. The method according to claim 1, wherein the at least one borate or borate derivative comprises at least one hydrate of sodium tetraborate.

6. The method according to claim 1, wherein the at least one borate or borate derivative comprises sodium tetraborate decahydrate.

7. The method according to claim 1, wherein the at least one anionic polymer comprises polystyrene sulfonate.

8. The method according to claim 1, wherein the first method comprises:
adding the at least one borate or borate derivative to the first composition to form a fourth composition; and
combining the at least one anionic polymer and the fourth composition to form the second composition.

9. The transparent ink-jet recording film prepared according to the method of claim 1.

10. A transparent ink-jet recording film exhibiting superior ink-drying performance prepared by a method comprising:
forming a first composition comprising gelatin;
forming a second composition by a first method comprising adding at least one borate or borate derivative to the first composition, the second composition comprising at least one anionic polymer; and
forming the transparent ink-jet recording film by a second method comprising forming at least one under-layer from the second composition.
